(19) United States
(12) Patent Application Publication
(10) Pub. No.: US 2006/0279973 A1
(43) Pub. Date: Dec. 14, 2006

(54) High efficiency DC to AC power converter

(76) Inventors: Cheng-Chia Hsu, Chupei City (TW); Yun-Ching Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/150,200

(22) Filed: Jun. 13, 2005

(51) Int. Cl. H02M 7/537

(52) U.S. Cl. 363/131

(57) ABSTRACT

A high efficiency DC to AC power converter capable of achieving zero switching by provision of an inductive resistance in a conversion circuit. The inductive resistance may take a form of a single inductance, an inductance connected in series with a capacitor, an inductor, a capacitor and a resistor connected in series, or a capacitor, an inductor, a capacitor and a resistor connected in series and parallel. In addition, the inductive resistance may be provided in a semi- or full-wave conversion circuit for the high efficiency DC to AC power covnerter.

### BACKGROUND OF THE INVENTION

1. Field of the Invention

The present invention relates to a high efficiency direct current (DC) to alternative current (AC) power converter and particularly to a high efficiency DC to AC power converter capable of achieving zero switching by provision of an inductive resistance in a conversion circuit therefor.

2. Description of the Prior Art

FIG. 1 and FIG. 2 show a semi-wave and a full-wave conversion circuit for a conventional direct current (DC) to alternative current (AC) power converter, respectively. For both the semi-wave or full-wave conversion circuits, a lamp A therein is capacitive. For a switch B, an AC power is provided to the load, lamp A, since it is conversed from an AC power. Thus, the conversed AC power is also capacitive. According to the related knowledge, the capacitive load may not achieve zero switching in the DC to AC converter and thus switching loss is increased and power conversion efficiency is adversely influenced. To see a relationship of voltage versus current of such conversion circuit, FIG. 3 may be referred to.

Therefore, the above mentioned conversion circuits are inherent with some shortcomings and required to be improved.

In view of these problems encountered in the prior art, the Inventors have paid many efforts in the related research and finally developed successfully a high efficiency DC to AC power converter, which is taken as the present invention.

### SUMMARY OF THE INVENTION

It is, therefore, an object of the present invention to provide a high efficiency DC to AC power converter capable of achieving zero switching by provision of an inductive resistance in a conversion circuit therefor.

It is another object of the present invention to provide a high efficiency DC to AC power converter capable of enhancing power conversion efficiency.

The high efficiency DC to AC power converter according to the present invention comprises a DC power generator, a filter/rectifier, a transformer, a lamp, a controller and an inductive resistance. The controller is used to activate or deactivate the filter/rectifier. The filter/rectifier is used to acquire and rectify and filter a DC power transmitted from the DC power generator. Then, the inductive resistance is used to converse an overall resistance into being inductive. Finally, the transformer converses the rectified and filtered DC power into an AC power. As such, the purpose of zero switching is achieved and power conversion efficiency of the power converter is thus enhanced. The inductive resistance may take a form of a single inductance, an inductance and a capacitor connected in series therewith, an inductor, a capacitor and a resistor connected in series therewith, or an inductor, a capacitor and a resistor connected in series and parallel therewith. The filter/rectifier may be a semi-wave rectifier or a full-wave rectifier.

### BRIEF DESCRIPTION OF THE DRAWINGS

The drawings disclose an illustrative embodiment of the present invention which serves to exemplify the various advantages and objects hereof, and are as follows:

FIG. 1 shows a semi-wave conversion circuit for a conventional DC to AC converter;

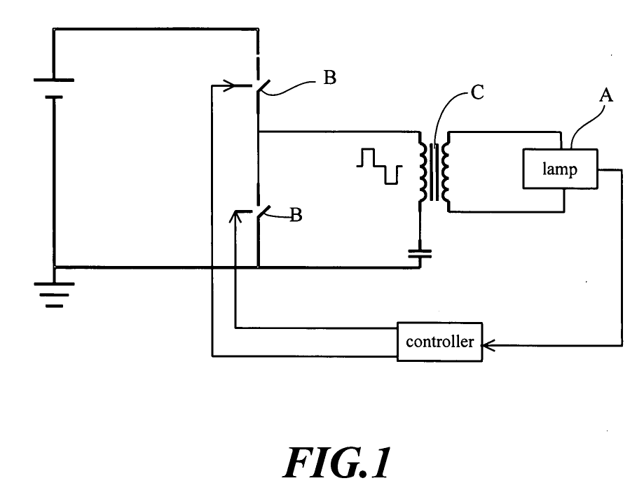

FIG. 2 shows a full-wave conversion circuit for the conventional DC to AC converter;

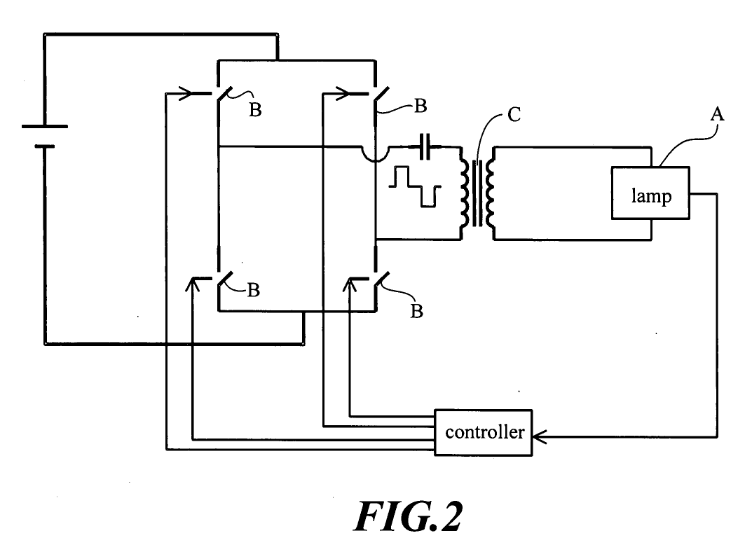

FIG. 3 shows a voltage versus current plot of the conventional DC to AC power converter;

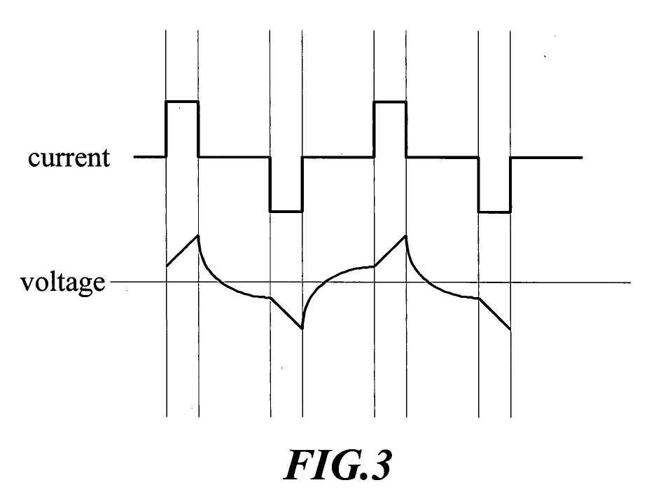

FIG. 4 shows a first conversion circuit form of a DC to AC power converter according to the present invention;

FIG. 5 shows a second conversion circuit form of the DC to AC power converter according to the present invention;

FIG. 6 shows a third conversion circuit form of the DC to AC power converter according to the present invention;

FIG. 7 shows a fourth conversion circuit form of the DC to AC power converter according to the present invention;

FIG. 8 shows a fifth conversion circuit form of the DC to AC power converter according to the present invention;

FIG. 9 shows a sixth conversion circuit form of the DC to AC power converter according to the present invention;

FIG. 10A, FIG. 10B, FIG. 10C and FIG. 10D show forms of an inductive resistance provided in the conversion circuit of the high efficiency DC to AC power converter according to the present invention; and

FIG. 11 shows a voltage versus current plot of the high efficiency DC to AC power converter according to the present invention.

### DETAILED DESCRIPTION OF THE PREFERRED EMBODIMENT

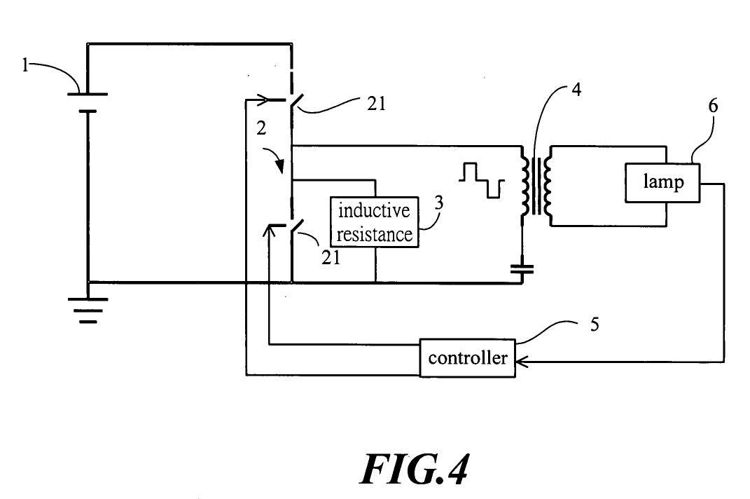

Referring to FIG. 4, a schematic diagram of a first conversion circuit for a high efficiency direct current (DC) to alternative current (AC) power converter according to the present invention is depicted therein. The first conversion circuit comprises a DC power generator 1, a semi-wave rectifier 2, an inductive resistance 3, a transformer 4, a controller 5 and a lamp 6. The semi-wave rectifier 2 is composed of two switches 21, which are operatively controlled by the controller 5 so that a DC power may be rectified and filtered. Specifically, a DC power transmitted from the DC power generator 1 is first acquired by the semi-wave rectifier 2 and then the acquired DC power is rectified and filtered. Next, the inductive resistance 3 enables an overall resistance to be inductive. Finally, the rectified and filtered DC power is conversed into an AC power through the transformer 4, the AC power being used as a power source of the lamp 6. In this manner, the purpose of zero switching may be achieved and thus power conversion efficiency of the DC to AC power converter may be enhanced.

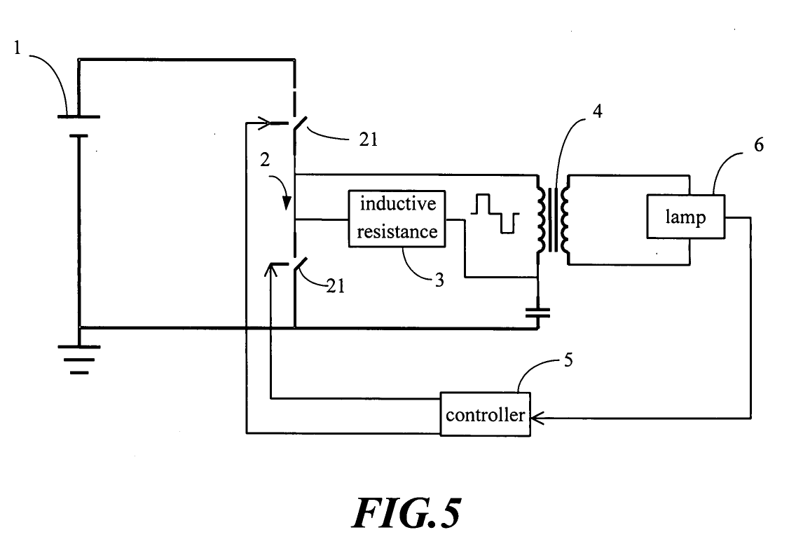

Referring to FIG. 5, the inductive resistance 3 may also be connected between two ends of the transformer 4 in achieving the same result of zero switching.

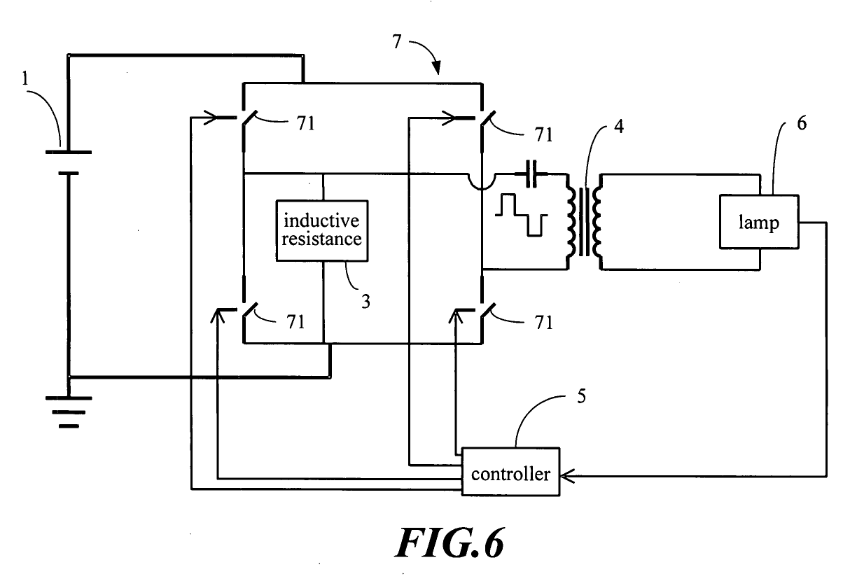

Referring to FIG. 6, in the case of the full-wave conversion circuit 7, the inductance resistance 3 may also be connected between a single end of the switch 71 and ground, which may also achieve the same result of zero switching.

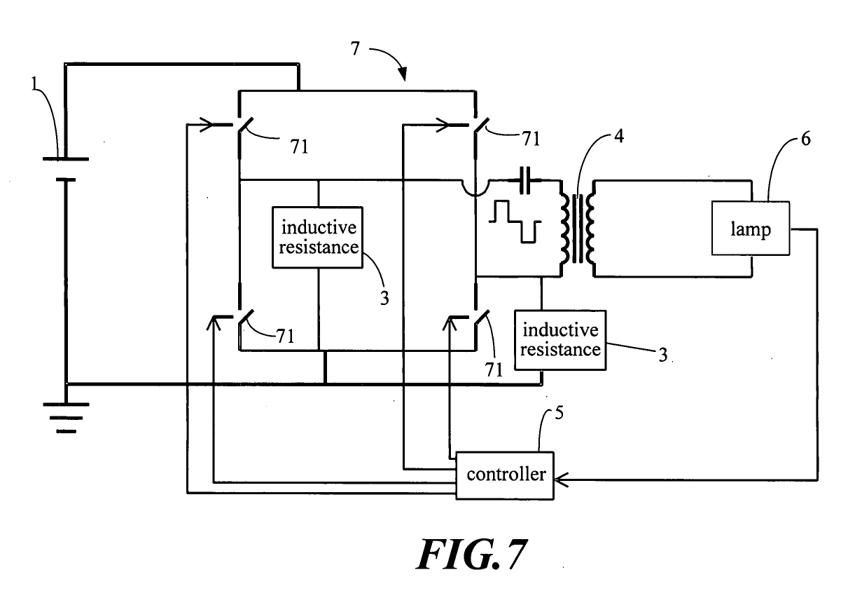

Referring to FIG. 7, in case of the full-wave conversion circuit 7, the inductive resistance 3 may also be connected between two ends of the switch 71 and ground, which may also achieve the same result of zero switching.

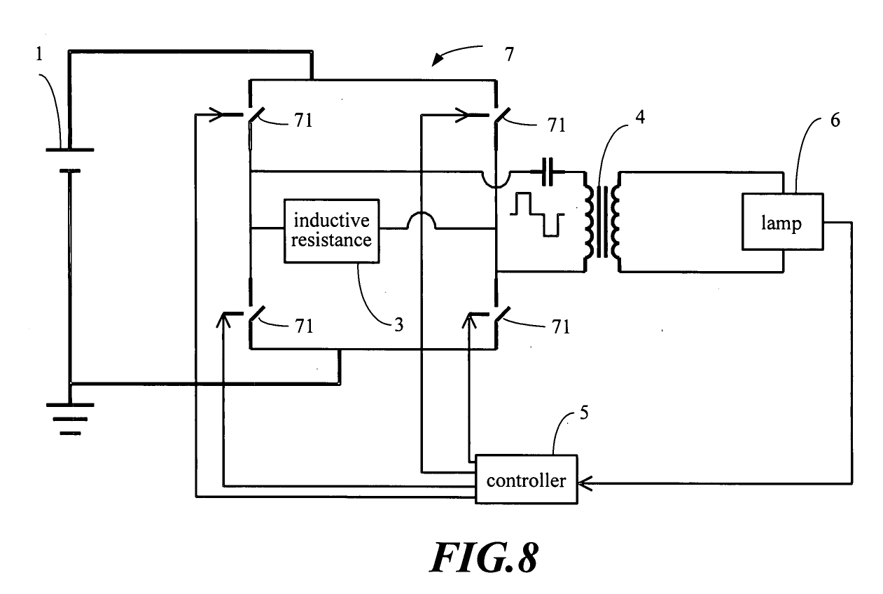

Referring to FIG. 8, in case of the full-wave conversion circuit 7, the inductive resistance 3 may also be connected at two ends of the switch 71, which may also achieve the same result of zero switching.

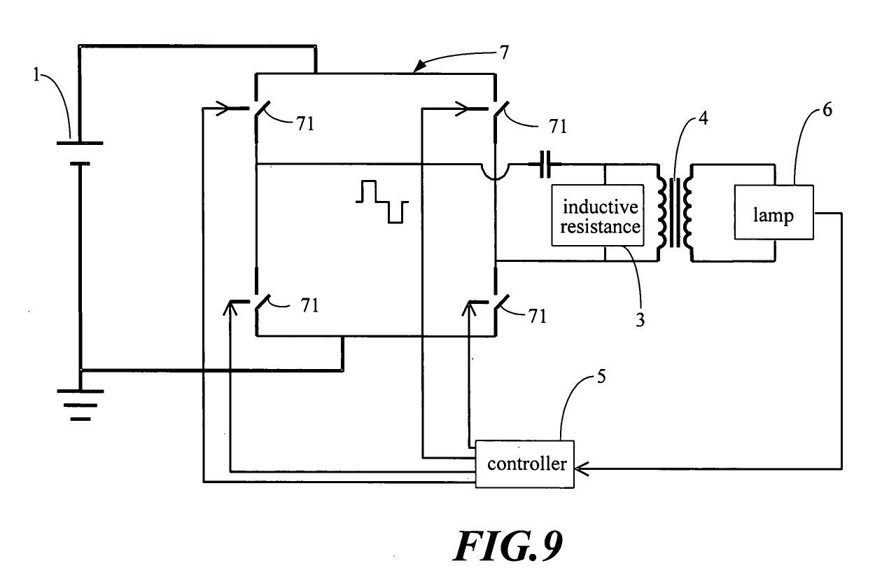

Referring to FIG. 9, in case of the full-wave conversion circuit 7, the inductive resistance 3 may also be connected at two ends of the transformer 4, which may also achieve the same result of zero switching.

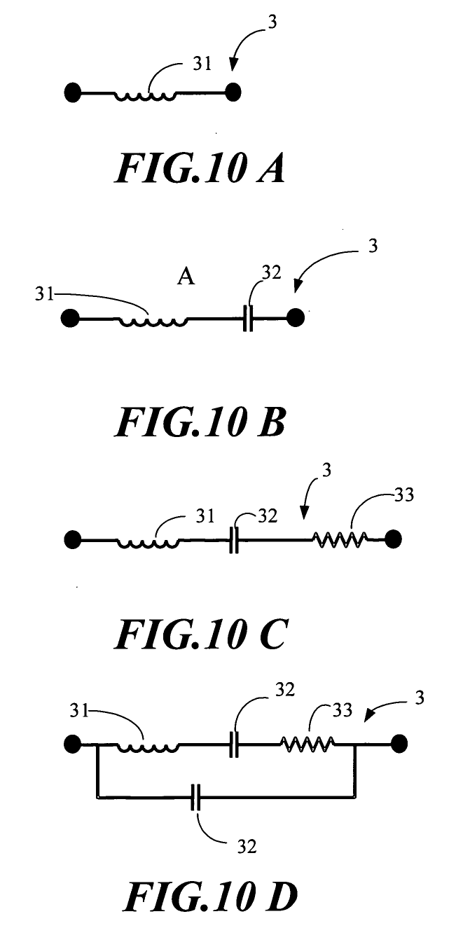

The inductive resistance may take a form of a single inductance 31 (shown in FIG. 10A), an inductance 31 connected in series with a capacitor 32 (shown in FIG. 10B), an inductor 31, a capacitor 32 and a resistor 33 connected in series (shown in FIG. 10C), or an inductor 31, a capacitor 32 and a resistor 33 connected in series and parallel (shown in FIG. 10D).

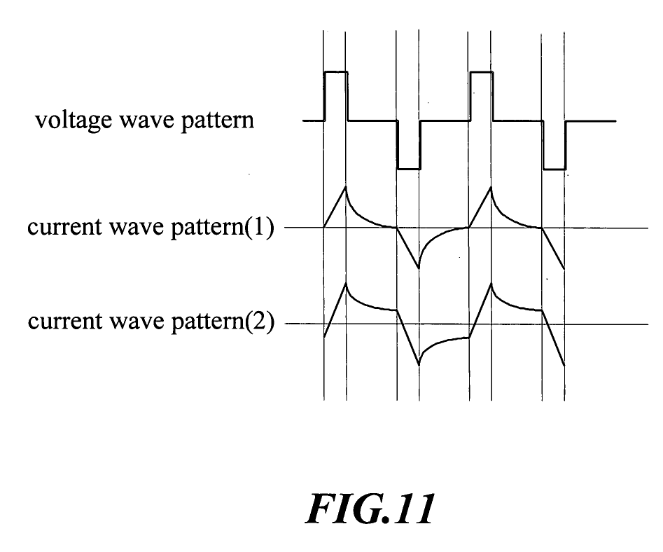

FIG. 11 shows a voltage versus current plot of the high efficiency DC to AC power converter with the inductive resistance provided. As shown, it may be readily appreciated that the purpose of zero switching can be achieved by replacing the load with the inductive resistance. As such, power conversion efficiency may be enhanced.

In conclusion, the high efficiency DC to AC power converter of this invention provides the advantage of achieving the purpose of zero switching by providing additionally an inductive resistance, compared with the prior art.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A high efficiency DC to AC power converter characterized in that an inductive resistance is provided additionally in a conversion circuit therefor.

2. The high efficiency DC to AC power converter according to claim 1, wherein the inductive resistance is in a form of a single inductor.

3. The high efficiency DC to AC power converter according to claim 1, wherein the inductive resistance is in a form of an inductor and a capacitor connected in series therewith.

4. The high efficiency DC to AC power converter according to claim 1, wherein the inductive resistance is in a form of an inductor, a capacitor and a resistor connected in series therewith.

5. The high efficiency DC to AC power converter according to claim 1, wherein the inductive resistance is in a form of an inductor and a capacitor connected in parallel therewith.

6. The high efficiency DC to AC power converter according to claim 1, wherein the inductive resistance is connected between the switch and ground when the conversion circuit is a semi-wave conversion circuit.

7. The high efficiency DC to AC power converter according to claim 1, wherein the inductive resistance is connected at two ends of the transformer when the conversion circuit is a semi-wave conversion circuit.

8. The high efficiency DC to AC power converter according to claim 1, wherein the inductive resistance is connected between a single end and ground when the conversion circuit is a full-wave conversion circuit.

9. The high efficiency DC to AC power converter according to claim 1, wherein the inductive resistance is connected between two ends of the switch and ground when the conversion circuit is a full-wave conversion circuit.

10. The high efficiency DC to AC power converter according to claim 1, wherein the inductive resistance is connected at two ends of the switch when the conversion circuit is a full-wave conversion circuit.

11. The high efficiency DC to AC power converter according to claim 1, wherein the inductive resistance is connected at two ends of the transformer when the conversion circuit is a full-wave conversion circuit.
